(19) United States
(12) Patent Application Publication
(10) Pub. No.: US 2026/0113727 A1
(43) Pub. Date: Apr. 23, 2026

(54) SIDELINK SYNCHRONIZATION DURING USER EQUIPMENT SELECTION

(71) Applicant: Nokia Technologies Oy, Espoo (FI)

(72) Inventors: Ali KARIMIDEHKORDI, Munich (DE); Prajwal KESHAVAMURTHY, Munich (DE); Diomidis MICHALOPOULOS, Munich (DE); Leonardo CHIARELLO, Munich (DE)

(21) Appl. No.: 19/153,835

(22) PCT Filed: Nov. 30, 2023
(86) PCT No.: PCT/EP2023/083729

§ 371 Date: Aug. 5, 2025

(30) Foreign Application Priority Data
Feb. 7, 2023 (FI) 20235119

(51) Int. Cl. H04W 64/00; H04L 5/00; H04W 56/00; H04W 92/10; H04W 92/18

(52) U.S. Cl. CPC H04W 64/00; H04L 5/0051; H04W 56/0015; H04W 92/10; H04W 92/18

(57) ABSTRACT

Systems, methods, apparatuses, and computer program products for sidelink (SL) synchronization during user equipment (UE) selection. A method may include receiving one or more messages from one or more devices of a selected set of devices. According to certain example embodiments, each of the one or more messages may include synchronization information. The method may also include selecting, based on the synchronization information, at least one device of the selected set of devices for a positioning communication session. The method may further include performing a positioning estimate of the apparatus based on positioning signals received through the positioning communication session from the at least one device of the selected set of devices.

### FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to apparatuses, systems, and/or methods for sidelink (SL) synchronization during user equipment (UE) selection.

### BACKGROUND

Examples of mobile or wireless telecommunication systems may include the Universal Mobile Telecommunications System (UMTS) Terrestrial Radio Access Network (UTRAN), LTE Evolved UTRAN (E-UTRAN), LTE-Advanced (LTE-A), MulteFire, LTE-A Pro, and/or fifth generation (5G) radio access technology or NR access technology. 5G wireless systems refer to the next generation (NG) of radio systems and network architecture. 5G network technology is mostly based on new radio (NR) technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the IoT.

### SUMMARY

Some example embodiments may be directed to a method. The method may include receiving one or more messages from one or more devices of a selected set of devices. According to certain example embodiments, each of the one or more messages may include synchronization information. The method may also include selecting, based on the synchronization information, at least one device of the selected set of devices for a positioning communication session. The method may further include performing a positioning estimate of the apparatus based on positioning signals received through the positioning communication session from the at least one device of the selected set of devices.

Other example embodiments may be directed to an apparatus. The apparatus may include at least one processor and at least one memory including computer program code. The at least one memory and computer program code may also be configured to, with the at least one processor, cause the apparatus at least to receive one or more messages from one or more devices of a selected set of devices. According to certain example embodiments, each of the one or more messages may include synchronization information. The apparatus may also be caused to select, based on the synchronization information, at least one device of the selected set of devices for a positioning communication session. The apparatus may further be caused to perform a positioning estimate of the apparatus based on positioning signals received through the positioning communication session from the at least one device of the selected set of devices.

Other example embodiments may be directed to an apparatus. The apparatus may include means for receiving one or more messages from one or more devices of a selected set of devices. According to certain example embodiments, each of the one or more messages comprises synchronization information. The apparatus may also include means for selecting, based on the synchronization information, at least one device of the selected set of devices for a positioning communication session. The apparatus may further include means for performing a positioning estimate of the apparatus based on positioning signals received through the positioning communication session from the at least one device of the selected set of devices.

In accordance with other example embodiments, a non-transitory computer readable medium may be encoded with instructions that may, when executed in hardware, perform a method. The method may include receiving one or more messages from one or more devices of a selected set of devices. According to certain example embodiments, each of the one or more messages may include synchronization information. The method may also include selecting, based on the synchronization information, at least one device of the selected set of devices for a positioning communication session. The method may further include performing a positioning estimate of the apparatus based on positioning signals received through the positioning communication session from the at least one device of the selected set of devices.

Other example embodiments may be directed to a computer program product that performs a method. The method may include receiving one or more messages from one or more devices of a selected set of devices. According to certain example embodiments, each of the one or more messages may include synchronization information. The method may also include selecting, based on the synchronization information, at least one device of the selected set of devices for a positioning communication session. The method may further include performing a positioning estimate of the apparatus based on positioning signals received through the positioning communication session from the at least one device of the selected set of devices.

Other example embodiments may be directed to an apparatus that may include circuitry configured to receive one or more messages from one or more devices of a selected set of devices. According to certain example embodiments, each of the one or more messages may include synchronization information. The apparatus may also include circuitry configured to select, based on the synchronization information, at least one device of the selected set of devices for a positioning communication session. The apparatus may further include circuitry configured to perform a positioning estimate of the apparatus based on positioning signals received through the positioning communication session from the at least one device of the selected set of devices.

Some example embodiments may be directed to a method. The method may include receiving a request for synchronization information from a device. The method may also include performing a synchronization status evaluation as per the received request with one or more devices of a set of devices. The method may further include transmitting one or more messages to the device based on the synchronization status evaluation. According to certain example embodiments, each of the one or more messages may include the synchronization information. In addition, the method may include receiving a positioning session establishment request based on the synchronization information. Further, the method may include performing positioning with the device in response to the positioning establishment request.

Other example embodiments may be directed to an apparatus. The apparatus may include at least one processor and at least one memory including computer program code. The at least one memory and computer program code may also be configured to, with the at least one processor, cause the apparatus at least to receive a request for synchronization information from a device. The apparatus may also be caused to perform a synchronization status evaluation as per the received request with one or more devices of a set of devices. The apparatus may further be caused to transmit one or more messages to the device based on the synchronization status evaluation. According to certain example embodiments, each of the one or more messages may include the synchronization information. In addition, the apparatus may be caused to receive a positioning session establishment request based on the synchronization information. Further, the apparatus may be caused to perform positioning with the device in response to the positioning establishment request.

Other example embodiments may be directed to an apparatus. The apparatus may include means for receiving a request for synchronization information from a device. The apparatus may also include means for performing a synchronization status evaluation as per the received request with one or more devices of a set of devices. The apparatus may further include means for transmitting one or more messages to the device based on the synchronization status evaluation. According to certain example embodiments, each of the one or more messages may include the synchronization information. In addition, the apparatus may include means for receiving a positioning session establishment request based on the synchronization information. Further, the apparatus may include means for performing positioning with the device in response to the positioning establishment request.

In accordance with other example embodiments, a non-transitory computer readable medium may be encoded with instructions that may, when executed in hardware, perform a method. The method may include receiving a request for synchronization information from a device. The method may also include performing a synchronization status evaluation as per the received request with one or more devices of a set of devices. The method may further include transmitting one or more messages to the device based on the synchronization status evaluation. According to certain example embodiments, each of the one or more messages may include the synchronization information. In addition, the method may include receiving a positioning session establishment request based on the synchronization information. Further, the method may include performing positioning with the device in response to the positioning establishment request.

Other example embodiments may be directed to a computer program product that performs a method. The method may include receiving a request for synchronization information from a device. The method may also include performing a synchronization status evaluation as per the received request with one or more devices of a set of devices. The method may further include transmitting one or more messages to the device based on the synchronization status evaluation. According to certain example embodiments, each of the one or more messages may include the synchronization information. In addition, the method may include receiving a positioning session establishment request based on the synchronization information. Further, the method may include performing positioning with the device in response to the positioning establishment request.

Other example embodiments may be directed to an apparatus that may include circuitry configured to receive a request for synchronization information from a device. The apparatus may also include circuitry configured to perform a synchronization status evaluation as per the received request with one or more devices of a set of devices. The apparatus may further include circuitry configured to transmit one or more messages to the device based on the synchronization status evaluation. According to certain example embodiments, each of the one or more messages may include the synchronization information. In addition, the apparatus may include circuitry configured to receive a positioning session establishment request based on the synchronization information. Further, the apparatus may include circuitry configured to perform positioning with the device in response to the positioning establishment request.

### BRIEF DESCRIPTION OF THE DRAWINGS

For proper understanding of example embodiments, reference should be made to the accompanying drawings, wherein:

FIG. 1 illustrates an example sidelink (SL) positioning scenario.

FIG. 2(a) illustrates an example of downlink-time difference of arrival (DL-TDOA) like SL positioning.

FIG. 2(b) illustrates an example of uplink-TDOA (UL-TDOA) like SL positioning.

FIG. 3 illustrates an example of priority groups of synchronization reference sources.

FIG. 4A illustrates an example of the SL positioning scenario signal flow diagram, according to certain example embodiments.

FIG. 4B illustrates a continuation of the SL positioning scenario signal flow diagram in FIG. 4A, according to certain example embodiments.

FIG. 4C illustrates a further continuation of the SL positioning scenario signal flow diagram in FIG. 4A, according to certain example embodiments.

FIG. 5 illustrates a further example of the SL positioning scenario signal flow diagram, according to certain example embodiments.

FIG. 6 illustrates an example flow diagram of a SL positioning method, according to certain example embodiments.

FIG. 7 illustrates a set of apparatuses, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for SL synchronization during UE selection. For instance, certain example embodiments may be directed to SL synchronization consideration during anchor UE selection.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “gNB”, “network” or other similar language throughout this specification may be used interchangeably. Additionally, the term “sync”, “synchronization”, “synchronicity” or other similar language throughout this specification may be used interchangeably.

As used herein, a target UE may refer to a UE to be positioned, and an anchor UE may refer to a UE that supports positioning of the target UE (e.g., by transmitting and/or receiving reference signals for positioning over a SL interface). Functions of the anchor UE (i.e., anchor node) may be similar to uplink/downlink (UL/DL) based positioning, where gNBs serving as anchors transmit/receive reference signals to/from target UEs for positioning. Additionally, as used herein, a SL positioning reference signal (PRS) may refer to a reference signal transmitted over the SL for positioning purposes.

SL PRS (pre-)configuration may collectively refer to (pre-)configured parameters of SL PRS such as, for example, time-frequency resources including its bandwidth and periodicity, and direction-related parameters (e.g., beam direction, beam width, and number of beams). SL PRS (pre)configuration may also refer to (pre-)configured parameters of SL PRS such as transmit power. Further, coverage or partial coverage may be determined by the network (e.g., by location management function (LMF) or gNB), and out-of-coverage may be pre-configured and/or determined by UEs autonomously. SL synchronization consideration during anchor UE selection may also involve a roadside unit (RSU) where a UE-type or gNB-type stationary infrastructure entity supports vehicle-to-everything V2X applications. Absolute positioning may refer to estimating the UE's position in 2D/3D geographic coordinates (e.g., latitude, longitude, elevation) within a coordinate system. Additionally, relative positioning may refer to estimation of position relatively to other network elements or relatively to other UEs. Further, ranging may refer to determination of the distance between two UEs and/or the direction of one UE from other UEs via direct device connection.

The technical specifications of 3^{rd} Generation Partnership Project (3GPP) considers SL positioning in cases such as, for example, V2X, public safety, and commercial and industrial-internet-of-things (IIoT). Further, 3GPP considers scenarios and requirements of in-coverage, partial coverage, and out-of-coverage NR positioning use cases that focus on V2X and public safety use cases. SA1 has developed requirements in 3GPP for ranging based services and has developed positioning accuracy requirements for IIoT use cases in out-of-coverage scenarios. The positioning requirements may be captured via key-performance indices (KPIs). KPIs may include, for example, horizontal and vertical accuracy, where vertical accuracy refers to accuracy in altitude and determines the floor for indoor use cases, and to distinguish between superposed tracks for road and rail use cases (e.g., bridges). KPIs may also include positioning service availability corresponding to a percentage value of the amount of time the positioning service is delivering the required position-related data within the performance requirements, divided by the amount of time the system is expected to deliver the positioning service according to the specification in the targeted service area. The KPIs may further include positioning service latency corresponding to time elapsed between an event that triggers the determination of the position-related data and the availability of the position-related data at the system interface. Additionally, the KPIs may include a time to fix (TTFF) corresponding to an amount of time elapsed between the event triggering for the first time the determination of the position-related data, and the availability of the position-related data at the position system interface. The KPIs may also include an update rate and energy consumption parameter.

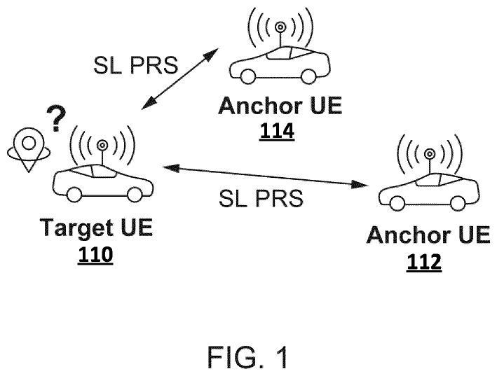

FIG. 1 illustrates an example SL positioning scenario. SL positioning may be based on the transmissions of SL-PRS by multiple anchor UEs 112-114 to be received by a target UE 110 (or SL-PRS exchange between the anchor and target UEs) to enable localization of the target UE 110 within precise latency and accuracy requirements of the corresponding SL positioning session. For instance, as illustrated in FIG. 1, a target UE 110 may be performing a SL positioning session (i.e., exchanging SL-PRS with at least two anchor UEs 112, 114 to determine the location of the target UE 110). In FIG. 1, the anchor UEs 112, 114 may provide SL-PRS assistance (including SL-PRS) to the target UE 110 to enable the target UE 110 to determine its location.

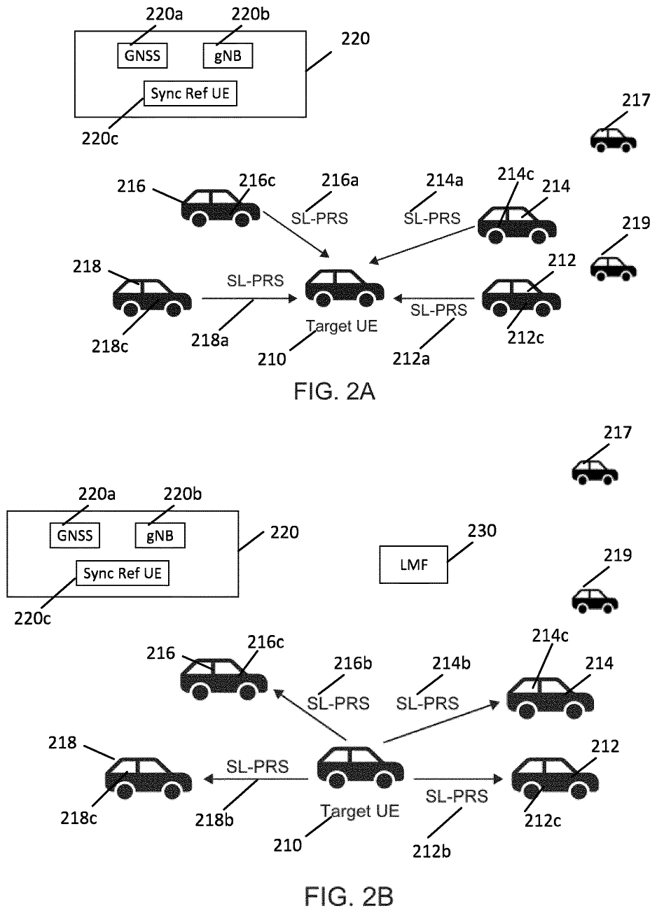

FIG. 2(a) illustrates an example of DL-time difference of arrival (DL-TDOA) like SL TDOA, and FIG. 2(b) illustrates an example of UL-TDOA like SL TDOA. SL-TDOA technique is a positioning technique that does not need two-way SL PRS transmissions between a transmitter and a receiver. 3GPP supports two types of TDOA techniques including, for example, DL-TDOA and UL-TDOA. SL-TDOA may be implemented with the similar concept and principle of DL-TDOA and UL-TDOA. In an example embodiment, the DL-TDOA and UL-TDOA may correspond to type 1 and type 2 of TDOA techniques, respectively. In DL-TDOA (technique type 1), as illustrated in FIG. 2(a), the target UE 210 may estimate a reference signal time difference (RSTD) measurement from SL positioning reference signals (212a-218a) transmitted by different anchor UEs (212-218) and compute the location of the target UE 210. In UL-TDOA (type 1), as illustrated in FIG. 2(b), the target UE 210 may transmit SL-PRS (212b-218b) to multiple anchor UEs 212-218, and the anchor UEs 212-218 may measure a relative time of arrival (RTOA) similar to UL-TDOA (type 2). This measurement may be reported to a location computing entity (e.g., LMF 230 or target UE 210) for positioning estimation of the target UE 210. Since both DL-TDOA and UL-TDOA procedures may be based on TDOA measurements, both procedures may need accurate time synchronization among reference UEs 212-218 to obtain an accurate positioning estimate of the target UE 210.

SL positioning may also involve SL transmissions that are organized in frames identified by a direct frame number (DFN). The DFN may enable a UE (e.g., anyone of 212-218) to synchronize its radio frame transmissions according to an SL timing reference 220. In an example embodiment, the UEs 212-218 may perform SL synchronization to have the same SL timing reference 220 for SL communication among nearby UEs by synchronizing with a same reference (e.g., SL timing reference 220). In an example embodiment, the reference 220, as shown in FIGS. 2(a) and 2(b) as a collective reference 220, which may include one or more of the multiple sources 220a to 220c for synchronization reference (SyncRef) including, for example, global navigation satellite system (GNSS) 220a, NR cell (gNB) or EUTRAN cell (eNB) 220b, SyncRef UE 220c. In another example embodiment, the SyncRef UE 220c may be anyone of the anchor UE's own internal clock (e.g., 212c-218c).

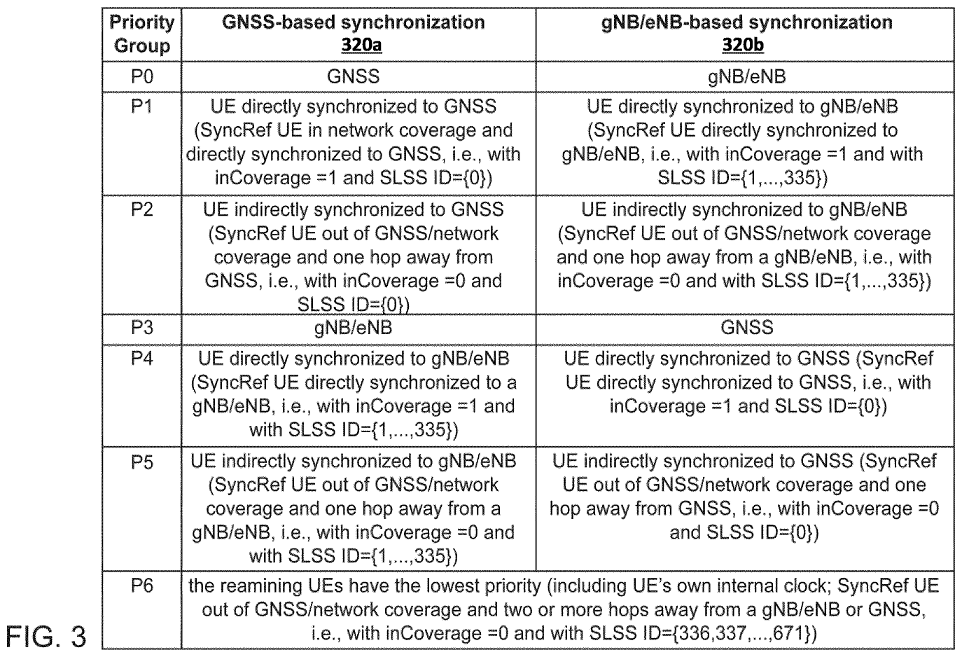

FIG. 3 illustrates an example of priority groups of synchronization reference sources. As illustrated in FIG. 3, a UE 210 may select its SyncRef (e.g., 220) with different priorities P0 to P6 of the sources (where P0 to P6 correspond to from the highest to the lowest priorities, respectively) depending on whether it is a GNSS-based 320a/220a synchronization (GNSS as the highest priority) or gNB/eNB-based synchronization 320b/220b (gNB/eNB has the highest priority).

As noted above (see also FIGS. 2(a) and 2(b) for illustration), in SL, UEs 212-218 may perform SL synchronization to have the same SL timing reference 220 for SL communication among nearby UEs (e.g., 212-218) by synchronizing with a same reference source 220. In the event that gNB/eNB 320b/220b or GNSS 320a/220a are not available as a synchronization reference source, a UE (e.g., UE 212) may perform SL synchronization by synchronizing with a SyncRef UE (e.g., UE 214). However, during this procedure, a synchronization misalignment may occur between UEs (212, 214) due to, for example, sync misalignment of their respective SyncRefs (e.g., 220d, 220e), the UE's own clock's stability (e.g., UE clocks 212c, 214c), and/or UE implementation error. Thus, in SL positioning, supporting and maintaining high-level synchronization among anchor UEs 212-218 may be difficult, especially considering that anchor UEs 212-218 may be built with significantly lower-cost hardware/software equipments compared to gNBs (e.g., 220b). Additionally, anchor UEs 212-218 may have lower processing capabilities than gNBs 220b, and the anchor UEs 212-218 may also be mobile UEs randomly distributed without any backhaul connection support.

In TDOA based SL positioning solutions, the positioning accuracy may depend on the synchronization precession between the anchor UEs (e.g., 212, 214), where 1 nsec timing misalignment may lead to a ˜36 cm positioning error. Thus, highly synchronized anchor UEs may be needed to support SL TDOA methods for meeting the accuracy requirements of SL positioning. However, not all the anchor UEs 212-218 may be well-synchronized as discussed above. Thus, if there is a synchronization misalignment among the anchor UEs 212-218 in the SL positioning session, the positioning accuracy of the target UE 210 may be degraded. In view of the drawbacks described above, certain example embodiments may provide a way to select/determine a set of anchor UEs 212-218 that are synchronized with a desired precision level so that a UE may perform accurate SL positioning. That is, certain example embodiments may include solutions for a target UE 210 of a SL positioning session with information about the synchronization accuracy between the anchor UEs 212-218 to allow for high accuracy positioning.

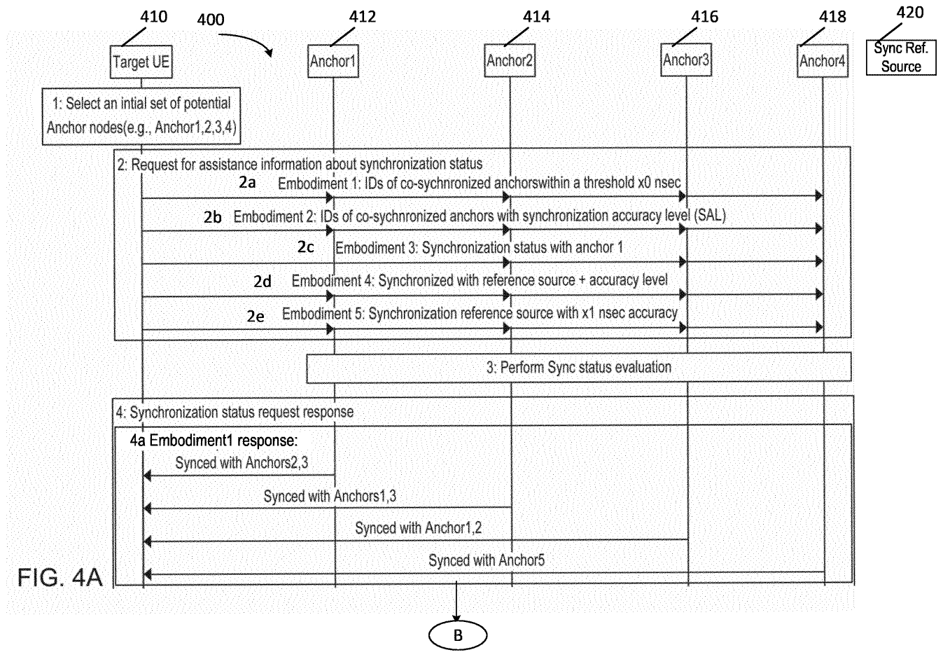

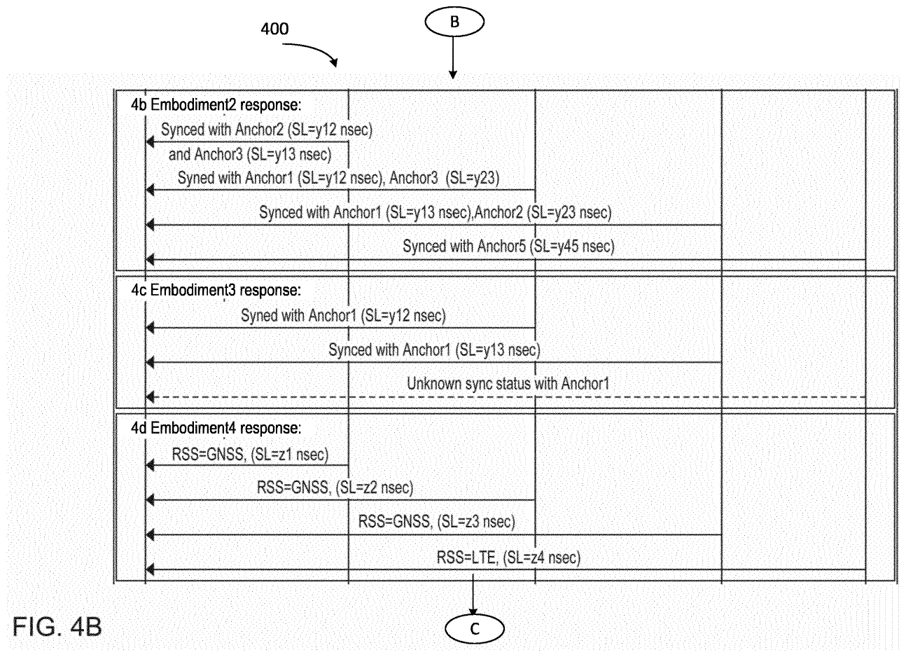

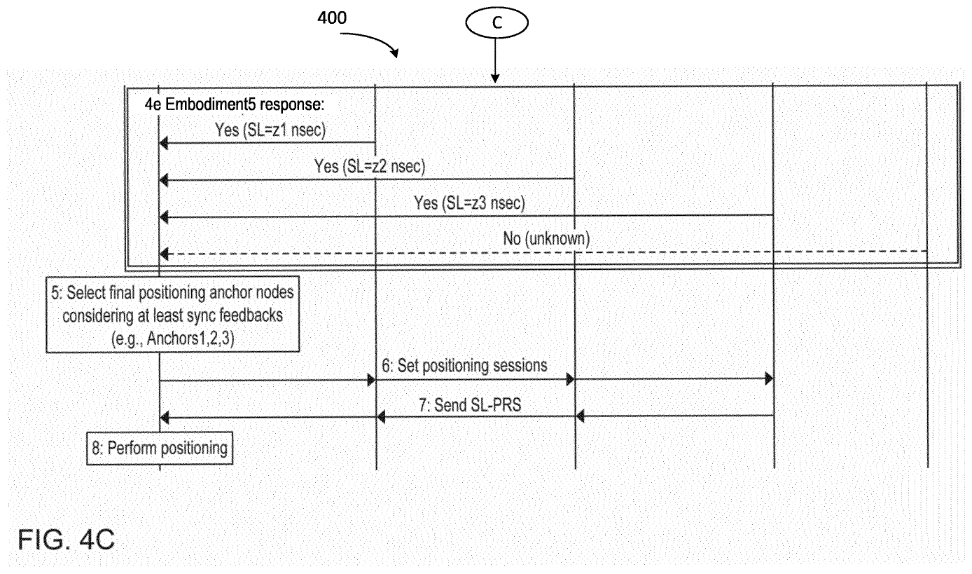

According to certain example embodiments, a first UE 210 (e.g., target UE) may be configured to perform certain operations with anchor UEs 212-218 including, for example, operations illustrated in FIGS. 4A-4C, which will be herein referenced. To simplify explanations and for illustration purposes, the described elements in FIG. 2 may be used to illustrate the description in FIGS. 4A to 4C, for example, UEs 210 to 218 in FIG. 2 may correspond to UEs 410 to 418 in FIGS. 4A to 4C. Likewise, elements 217, 219 and 220 although not explicitly shown in FIGS. 4A to 4C, may be considered to be functionally present for the sake of illustration and description.

For instance, the first UE 410 (e.g., target UE) may select a set of second UEs 412-418 (e.g., one or more of anchors 1 to 4) as candidate anchor UEs for SL positioning (e.g., see FIGS. 4A-4C, operation 1). The first UE 410 may also request (e.g., see FIGS. 4A-4C, operation 2) at least one second UE 412 (e.g., anyone or more of candidate anchor 1 UE, anchor 2 UE, anchor 3 UE, and/or anchor 4 UE) for synchronization (sync) status assistance information. According to certain example embodiments, the sync status assistance information may include at least one or more of various information elements (IEs). For instance, the IEs may include types of sync status assistance information desired at the target UE 410.

In some example embodiments, the sync status assistance information type may be of type 1, which may include sync status information about one or more other UEs 414 (i.e., anchor 2 in FIGS. 4A-4C) that may be co-synchronized with the second UE 412 (i.e., anchor 1), which may have a sync accuracy within an indicated sync accuracy threshold L1. In some example embodiments as shown in operation 2a, the sync accuracy threshold L1 may correspond to a real number (e.g., x0 nsec).

In certain example embodiments, the sync accuracy threshold (L1) may be explicitly or implicitly indicated by the first UE 410 in the request (i.e., operation 1) sent to the second UE 412. The type 1 sync status information, which the first UE 410 may request from the second UE 412, may include, for example, an identifier (ID) of one or more co-synchronized UEs (and potentially a number N of synched UEs, in this case N=2 for UE) , an ID of one or more non-synchronized UEs (i.e., 217, 219 as shown in FIG. 2), and/or a synchronization levels with respect to the other co-synchronized UEs 416-418 (e.g., anchors 3 and 4).

In other example embodiments (e.g., operation 2c), the IE may include sync status assistance information of type 2, which may include sync status information about a synchronization level L2 (i.e., synchronization threshold) with respect to one or more of third UE(s) (e.g., UE 412). In some example embodiments, the UE(s) 412 may be indicated by the first UE 410 in the request (i.e., operation 1) to the other anchor UEs 414, 416, 418.

In further example embodiments, the IE may include an information type of type 3, which may include information related to a synchronization reference source(s) of the second UE 412 (i.e., anchor 1 UE), or synchronization reference sources of other co-synchronized UEs (if available). In certain example embodiments, the target UE 410 may select one synchronization reference source 420 (similar to 220 in FIG. 2) and a threshold and request synchronization assistance information from anchor UEs (e.g., anyone of anchor UEs 412-418) that have the same synchronization reference source 220 within the threshold. In other example embodiments, the request to the second UE 412 may include information regarding reliability of synchronization (e.g., variance of synchronization error). For example, the reliability of synchronization may be between the anchor UEs, between anchor UEs and the reference source, or between the anchor UEs and one other selected UE (potentially an anchor UE). The reliability of synchronization may ensure that the anchor UEs are synchronized (e.g., anchors 2,3, anchors 1,3, anchors 1,2), whether or not the target UE is in sync with the anchor UEs.

According to certain example embodiments, the target UE 410 may receive sync status assistance information from one or more of the second UEs (i.e., anchor 1-4 or UEs 412-418; see FIGS. 4A-4C, operation 4 and 4a-4e), which may include one or more of the above example embodiments based on the requested type(s) of information. For instance, if the information is type 1, the target UE 410 may receive from anchor UE 412 IDs and/or the synchronization level of other co-synchronized nodes (e.g., anchor 414 and 416) with anchor UE 412, and/or IDs of other co-synchronized UEs 414-418 and the level L2 of synchronization between the second UE 412 and other UEs 414-418. In other example embodiments, the level may not be limited to level L2, and there may be multiple levels of synchronization. If the information is type 2, the information may include a level of synchronization between the second UE 412 and the indicated third UE(s) 414. Further, if the information is type 3, the information may include a SyncRef source of the second UE (e.g., SyncRef UE ID), or information on whether the same reference source 420 is used with a third UE 414.

In certain example embodiments, once the target UE 410 obtains the requested sync status assistance information, the target UE 410 may perform anchor UE (re)selection (anyone of anchors 1 to 4 or UEs 412-418; see FIGS. 4A-4C, operation 5) for SL positioning at least based on the sync status assistance information. Once the anchor UE(s) (e.g., anchor 1 or UE 412) has been selected, the target UE 410 may establish and perform SL communication with the selected anchor UE(s) (e.g., anchor 1 or UE 412; see FIGS. 4A-4C, operations 6-8).

According to certain example embodiments, the second UE 412 may receive the request (see FIG. 4A, operation 2) sent from the first UE 410, where the request may be for sync status information. Once the second UE 412 receives the request, the second UE 412 may perform a sync status evaluation (see FIG. 4A, operation 3) in accordance with the request. For instance, if the request is a type 1 or type 2 request, the second UE 412 (anchor 1) may coordinate with other anchor UEs 414-418 (e.g., anchors 2-4) on their positioning synchronization status. The second UE 412 may also receive positioning signals from the other anchor UEs 414-418, calculate a signal transmission time based on the location knowledge of the anchor UEs, and/or estimate a synchronization accuracy by considering anchor UE PRS transmission impairments. Further, the second UE 412 may communicate with a positioning reference point, and request synchronization information from other anchor UEs (414-418). The synchronization information may refer to the time drift between the transmission times of the reference signals of the given devices (e.g., anchor UEs). In some example embodiments, for sync accuracy determination, the second UE 412 may employ techniques such as, for example, ultra-wide band (UWB) signals. In certain example embodiments, if the request is a type 3 request, the second UE 412 may estimate its synchronization PRS drift compared to its synchronization reference source 420 or a positioning reference point.

According to certain example embodiments, the second UE 412 may transmit the sync status assistance information to the third UE 414 (see FIGS. 4A-4C, operation 4 and 4a-4e) in accordance with the received request. According to other example embodiments, the second UE 412 may receive a SL positioning establishment request from the target UE (see FIGS. 4A-4C, operation 6) and perform SL positioning (see FIGS. 4A-4C, operations 7 and 8) with the target UE 410 upon receiving the SL positioning establishment request.

FIGS. 4A-4C further illustrate an example signal flow diagram 400, according to certain example embodiments. As illustrated in FIGS. 4A-4C, the target UE 410 may request one or more initial selected anchor nodes 1-4 (i.e., anchor UEs 412-418) to provide feedback on anchor nodes (e.g., anchors 1,2; anchors 1,3; anchors 1,4; anchors 2,3; etc.) they are in synch with.

At operation 1, the target UE 410 may detect potential anchor UEs (anchors 1-4), and select a subset of anchor UEs (e.g., anchors 1,2) for triggering an initial SL positioning session. According to certain example embodiments, detection by the target UE 410 may be performed using direct discovery models (e.g., model A and/or B), or an indirect model. The target UE 410 may then select an initial set of anchor nodes for positioning information exchange. According to certain example embodiments, the selection may be based on basic information (i.e., received signal quality, periodicity, and/or bandwidth) received from discovery messages plus additional information achieved by measurements/estimations of received reference signals (or discovery messages). For instance, the measurements/estimations may include proximity, previous positioning experience, line-of-sight (LOS) conditions, received reference signal received power (RSRP) or reference signal received quality (RSRQ), etc. In the example of FIGS. 4A-4C, it may be assumed that the target UE 410 selects anchor nodes 1 to 4 (i.e., anchors 412-418) for an initial positioning information exchange. However, in other example embodiments more anchors may be selected.

At operation 2, the target UE 410 may send a request to at least one of the initially selected anchor UEs (e.g., one or more of anchor nodes 1-4). The request may include at least a request for assistance information about the synchronization status (and potentially additional information required for SL positioning). In certain example embodiments, the request may be a request for co-synchronized anchors within a threshold (e.g., 2a Embodiment 1 in FIG. 4A). For instance, in this example embodiment, the target UE may determine a synchronization accuracy threshold (e.g., x0 nsec), and request the selected anchor node to provide feedback with the IDs of other anchor nodes (e.g., any of anchors 412-418, or anchors other than 412-418) that are co-synchronized with the selected anchor node within the predefined threshold. As illustrated in FIGS. 4A-4C, the target UE 410 may send the request to anchor nodes 1-4. Alternatively, in other example embodiments, the target UE 410 may also request the selected anchors 1-4 to report non-synchronized anchors (i.e., other anchors different from anchors 412-418) in a certain area.

In other example embodiments, the request may be a request for co-synchronized anchors which meet the synchronization accuracy threshold set by the target UE (e.g., 2b Embodiment 2 in FIG. 4A). For instance, in this example embodiment, the target UE 410 may request anchor nodes 1-4 to provide feedback of at least N co-synchronized UEs (i.e., same or different anchors from anchors 412-418) and their corresponding synchronization accuracy level. In certain example embodiments, the synchronization accuracy level may correspond to a discretized number or levels such as low, medium, and high with different accuracy value ranges.

According to certain example embodiments, the request may be a request for synchronization status with respect to another anchor UE (e.g., 2b Embodiment 3 in FIG. 4A). For instance, in this example embodiment, the target UE may determine an (or a set of) anchor node(s) (e.g., anchor1) and a synchronization threshold. The target UE may then request other anchor nodes to provide feedback to the target UE on whether the other anchor nodes are synchronized with the specified anchor node (i.e., anchor1) within the predefined threshold. Alternatively, in other example embodiments, the target UE may request anchors 1-4 to provide feedback on their synchronicity accuracy level.

In certain example embodiments, the request may be a request for a synchronization reference source (e.g., 2d Embodiment 4 in FIG. 4A). For instance, in this example embodiment, the target UE message/request may include a request for information about a reference synchronization source, and the anchor node accuracy estimation of its PRS signals with respect to the reference source. In other example embodiments, the target UE 410 may request the anchor nodes 1-4 to provide information on the source and synchronicity level of other anchor nodes corresponding to anchors 412-418 or anchors different from anchors 412-418 (if available due to inter-UE coordination between anchor nodes).

According to certain example embodiments, the request may be a request for a synchronization reference source with a threshold (e.g., 2e Embodiment 5 in FIG. 4B). For instance, in this example embodiment, the target UE may determine/select a synchronization reference source 420 (e.g., GNSS) and a threshold margin (e.g., x1 nsec), and request anchor nodes (e.g., candidate anchor UEs) that use a similar reference source 420 and are synchronized within the predefined threshold to respond.

In addition to the various requests described above that may be sent by the target UE, in other example embodiments, the target UE may request feedback from the anchor nodes 1-4 on the sustainability of the synchronization between the anchor nodes 1-4. In this example embodiment, the selected anchor node(s) may provide feedback on the time duration in which it can maintain synchronization (with the predefined precision and reliability level) with other anchor nodes such as any of anchors 412-418 or additional anchors (or reference source). In other example embodiments, the target UE may also request for the feedback from the selected anchor node about its supported coverage and time duration of SL-PRS transmission. In some example embodiments, some anchor nodes may be able to broadcast SL-PRS for a limited period of time, in a certain direction (i.e., certain panel in FR2), as well as having limited power (or beam gain in FR2) for SL-PRS transmission with higher power that can be received from a longer distance when the target UE is mobile. In certain example embodiments, depending on the scenario, the target UE 410 may not necessarily ask all the anchor UEs 412-418 to respond.

Returning to FIG. 4A, at operation 3, the anchor nodes 1-4 may receive the request from the target UE and perform the request sync evaluation. According to certain example embodiments, the sync evaluation between anchor nodes may be achieved by applying different methods such as, for example, coordination between anchor nodes, communication with a positioning reference unit, using UWB signals, etc.

At operation 4, the anchor UEs may respond to the target UE positioning synchronization request by providing the target UE with at least the required synchronization information. For instance, in certain example embodiments, as response to the target UE request in 2a of operation 2 where the target UE requests to have the IDs of co-synchronized nodes with accuracy threshold of x0 nsec (e.g., 4a Embodiment 1 response in FIG. 4A), the synchronization information may include a response from anchor node 1 that it is in sync with anchor node 2 and anchor node 3. Further, anchor node 2 may respond that it is in sync with anchor node 1 and anchor node 3. Additionally, anchor node 3 may respond that it is in sync with anchor nodes 1 and 2. Further, anchor node 4 may respond that it is in sync with anchor node 5 (anchor node 5 not shown in FIG. 4A).

As further illustrated in FIG. 4A, as a response to the target UE request in 2b of operation 2 where the target UE requests to have the IDs of co-synchronized nodes plus the synchronization level (SL) (e.g., 4b Embodiment 2 response in FIG. 4A), anchor node 1 may respond that it is in sync with anchor node 2 with a SL value of SL=y₁₂ nsec, and anchor node 3 with SL=y₂₃ nsec. Further, anchor node 3 may respond that it is in sync with anchor node 2 with SL=y₂₃ nsec, and anchor node 1 with SL=y₁₃ nsec. Additionally, anchor node 4 may respond that it is in sync with anchor node 5 with SL=y₄₅ nsec.

FIG. 4A also illustrates that as a response to the target UE request in 2c of operation 2 where the target UE requests for synchronization status with respect to another anchor UE (i.e., whether anchor nodes are in sync with anchor node 1 with an SL better than 1x nsec) (e.g., 4c Embodiment 3 response in FIG. 4). In this example embodiment, anchor node 2 may respond that it is in sync with anchor node 1 with SL=y₁₂ nsec. Further, anchor node 3 may respond that it is in sync with anchor node 1 with SL=y₁₃ nsec. Additionally, anchor node 4 may respond with an unknown sync status with anchor node 1.

As further illustrated in FIG. 4, as a response to the target UE request in 2d operation 2 where the target UE requests information about the anchor nodes' reference synchronization source (RSS) and the anchor node's estimated PRS estimation accuracy (e.g., 4d Embodiment 4 response in FIG. 4A), anchor node 1 may respond that its RSS=GNSS, with an SL=z1 nsec. Further, anchor node 2 may respond that its RSS=GNSS, with an SL=z2 nsec. Additionally, anchor node 3 may respond that its RSS=GNSS, with an SL=z3 nsec. Further, anchor node 4 may respond that its RSS=LTE eNB with an SL=z4 nsec.

In FIG. 4A, as a response to the target UE request in 2e operation 2 where the target UE requests if anchor nodes are using GNSS as a reference synchronization source 420 with SL better than w0 nsec (e.g., 4e Embodiment 5 response in FIG. 4B), anchor node 1 may respond with “yes” along with an SL=z1 nsec. Further, anchor node 2 (UE 414) may respond with “yes” along with an SL=z2 nsec. Additionally, anchor node 3 (UE 416) may respond with “yes along with an SL=z3 nsec, and anchor node 4 may or may not provide a response.

At operation 5 in FIG. 4B, the target UE 410 may realize that anchor nodes (e.g., anchor nodes 1, 2, 3) are sufficiently synchronized with each other, and the same for anchor nodes 4 UE 418) and anchor node 5 (not shown in FIG. 4B, but similar to UE 217 or UE 219 in FIGS. 2A-2B). By taking other factors (e.g., received signal power/quality, bandwidth, periodicity of the signal, signal duration length, etc.) into account, the target UE may determine to establish the positioning session with anchor nodes 1, 2, and 3. As further illustrated in FIG. 4C, at operation 6, the target UE 410 may establish a positioning session with the selected anchor nodes (e.g., anchor nodes 1, 2, and 3). Additionally, at operation 7, anchor nodes 1, 2, and 3 may broadcast SL-PRS to the target UE 410, and at operation 8, the target UE 410 may perform TDOA positioning based on the received SL-PRS signals.

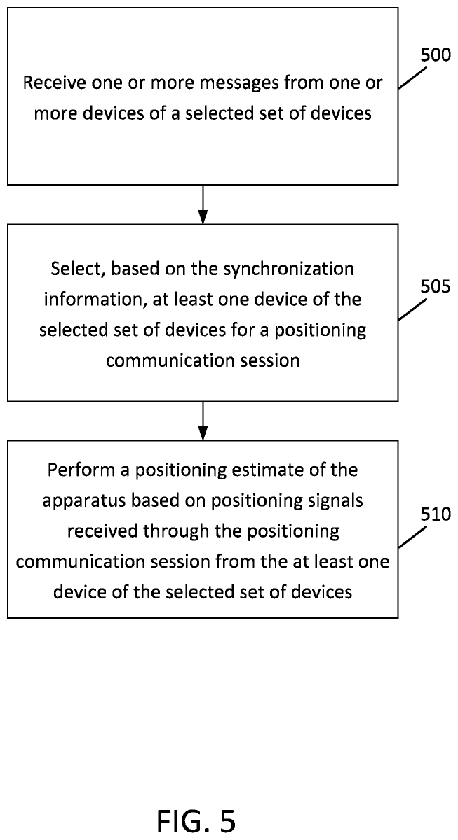

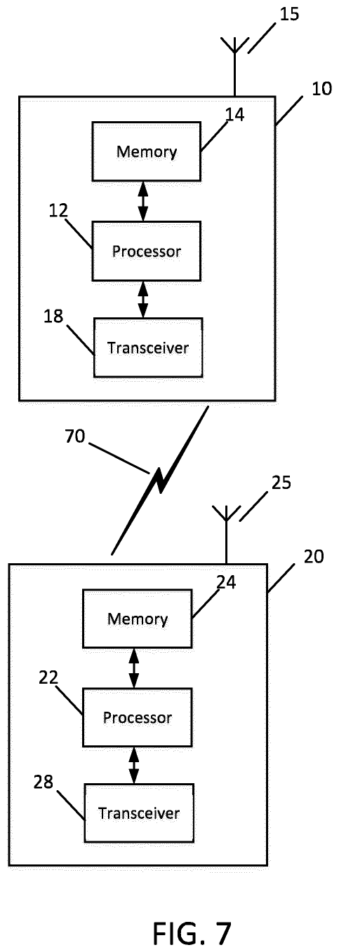

FIG. 5 illustrates an example flow diagram of a method, according to certain example embodiments. In an example embodiment, the method of FIG. 5 may be performed by a network entity, network node, or a group of multiple network elements in a 3GPP system, such as LTE or 5G-NR. For instance, in an example embodiment, the method of FIG. 5 may be performed by a target UE, for instance, similar to apparatuses 10 or 20 illustrated in FIG. 7.

According to certain example embodiments, the method of FIG. 5 may include, at 500, receiving one or more messages from one or more devices of a selected set of devices. According to certain example embodiments, each of the one or more messages may include synchronization information. The method may also include, at 505, selecting, based on the synchronization information, at least one device of the selected set of devices for a positioning communication session. The method may further include, at 510, performing a positioning estimate of the apparatus based on positioning signals received through the positioning communication session from the at least one device of the selected set of devices.

According to certain example embodiments, the synchronization information may include at least one of identifiers of one or more other devices of the selected set of devices that are co-synchronized with the one or more devices of the selected set of devices and with one or more devices different from the selected set of devices, identifiers of one or more other devices of the selected set of devices, and a level of synchronization between the one or more devices of the selected set of devices and the one or more other devices of the selected set of devices and with one or more devices different from the selected set of devices, a level of synchronization between the one or more devices of the selected set of devices and one or more other devices of the selected set of devices and with one or more devices different from the selected set of devices, an indication that the one or more devices of the selected set of devices uses a same synchronization reference source as the one or more other devices of the selected set of devices and with one or more devices different from the selected set of devices, or an indication of reliability of synchronization.

According to some example embodiments, the method may also include selecting the selected set of devices from a plurality sets of devices, and transmitting, to the one or more devices of the selected set of devices, a request for the synchronization information from the selected set of devices. According to certain example embodiments, the selection of the set of devices is performed prior to the transmission of the request for the synchronization information. According to other example embodiments, the positioning signals received from the at least one device of the selected set of devices may include a positioning reference signal.

In certain example embodiments, the synchronization information may include synchronization status assistance information indicating at least a synchronization level threshold. In some example embodiments, the positioning signals may be received from the at least one device of the selected set of devices via one or both of a sidelink interface and an air interface. In other example embodiments, the synchronization information is received from one of a network node, a peer anchor user equipment, or a global navigation satellite system. In further example embodiments, the selected set of devices may include anchor user equipment, and the apparatus is a target user equipment.

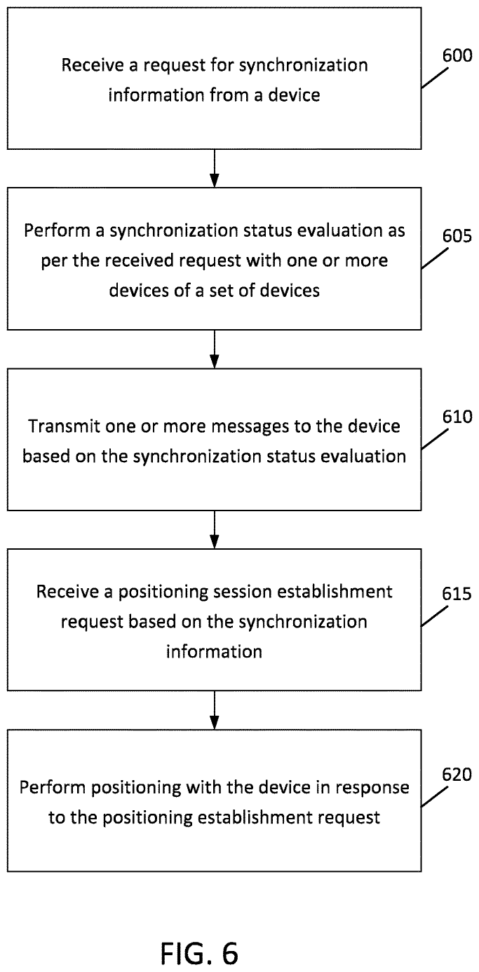

FIG. 6 illustrates an example flow diagram of a method, according to certain example embodiments. In an example embodiment, the method of FIG. 6 may be performed by a network entity, network node, or a group of multiple network elements in a 3GPP system, such as LTE or 5G-NR. For instance, in an example embodiment, the method of FIG. 6 may be performed by an anchor UE (i.e., anchor node), for instance, similar to apparatuses 10 or 20 illustrated in FIG. 7.

According to certain example embodiments, the method of FIG. 6 may include, at 600, receiving a request for synchronization information from a device. The method may also include, at 605, performing a synchronization status evaluation as per the received request with one or more devices of a set of devices. The method may further include, at 610, transmitting one or more messages to the device based on the synchronization status evaluation. According to certain example embodiments, each of the one or more messages may include the synchronization information. In addition, the method may include, at 615, receiving a positioning session establishment request based on the synchronization information. Further, the method may include, at 620, performing positioning with the device in response to the positioning establishment request.

According to certain example embodiments, performance of the synchronization status evaluation may include at least one of coordinating with one or more other devices of the set of devices on a positioning synchronization status, receiving positioning signals from the one or more other devices of the set of devices, calculating a signal transmission time based on location knowledge of the one or more devices of the set of devices, and estimating a synchronization accuracy by considering positioning reference signal transmission impairments, or communicating with a positioning reference point, and requesting synchronization information of the one or more other devices of the set of devices.

According to some example embodiments, performance of the synchronization status evaluation may include estimating a synchronization positioning reference signal drift of the apparatus compared to a synchronization reference source or a positioning reference point of the apparatus. According to other example embodiments, the synchronization information comprises at least one of identifiers of the one or more other devices of the set of devices that are co-synchronized with the one or more devices of the set of devices, identifiers of one or more other devices of the set of devices, and a level of synchronization between the one or more devices of the set of devices and the one or more other devices of the set of devices, a level of synchronization between the one or more devices of the set of devices and the one or more other devices of the set of devices, an indication that the one or more devices of the set of devices uses a same synchronization reference source as the one or more other devices of the set of devices, or an indication of reliability of synchronization.

In certain example embodiments, the synchronization information may include synchronization status assistance information which indicates at least a synchronization level threshold. In some example embodiments, the synchronization information is transmitted from one of a network node, a peer anchor user equipment, or a global navigation satellite system. In other example embodiments, the one or more other devices of the set of devices may include anchor user equipment, and the device is a target user equipment.

In certain example embodiments, an apparatus 10 may include at least one processor 12, and at least one memory 14 including computer program code. The at least one memory 14 and the computer program code may be configured to, with storing instructions that, when executed by the at least one processor 12, cause the apparatus 10 to receive one or more messages from one or more devices of a selected set of devices (e.g., steps 4a-4e in FIGS. 4A-4C). According to certain example embodiments, each of the one or more messages may include synchronization information. According to other example embodiments, the apparatus 10 may also be caused to select, based on the synchronization information, at least one device of the selected set of devices for a positioning communication session (e.g., steps 5 and 6 in FIGS. 4A-4C). According to further example embodiments, apparatus 10 may be caused to perform a positioning estimate of the apparatus based on positioning signals received through the positioning communication session from the at least one device of the selected set of devices (e.g., steps 7 and 8 in FIGS. 4A-4C).

In certain example embodiments, the synchronization information may include at least one of identifiers of one or more other devices of the selected set of devices that are co-synchronized with the one or more devices of the selected set of devices and with one or more devices different from the selected set of devices (e.g., type 1 information), identifiers of one or more other devices of the selected set of devices, and a level of synchronization between the one or more devices of the selected set of devices and the one or more other devices of the selected set of devices and with one or more devices different from the selected set of devices (e.g., type 1 information), a level of synchronization between the one or more devices of the selected set of devices and one or more other devices of the selected set of devices and with one or more devices different from the selected set of devices (e.g., type 2 information), an indication that the one or more devices of the selected set of devices uses a same synchronization reference source as the one or more other devices of the selected set of devices and with one or more devices different from the selected set of devices (e.g., type 3 information), or an indication of reliability of synchronization.

According to certain example embodiments, the at least one memory 14 and the computer program code may further be configured to, with storing instructions that, when executed by the at least one processor 12, cause the apparatus 10 to select the selected set of devices from a plurality sets of devices (e.g., step 1 in FIGS. 4A-4C), and transmit, to the one or more devices of the selected set of devices, a request for the synchronization information from the selected set of devices (e.g., steps 2a-2e in FIGS. 4A-4C). According to some example embodiments, the selection of the set of devices may be performed prior to the transmission of the request for the synchronization information.

In certain example embodiments, the positioning signals received from the at least one device of the selected set of devices may include a positioning reference signal (e.g., steps 7 and 8 in FIGS. 4A-4C). In some example embodiments, the synchronization information may include synchronization status assistance information indicating at least a synchronization level threshold (e.g., steps 2a-2e in FIGS. 4A-4C). In other example embodiments, the positioning signals may be received from the at least one device of the selected set of devices via one or both of a sidelink interface and an air interface (e.g., step 7 in FIGS. 4A-4C).

According to certain example embodiments, the synchronization information is received from one of a network node, a peer anchor user equipment, or a global navigation satellite system (e.g., steps 4a-4e and 5 in FIGS. 4A-4C). According to further example embodiments, the selected set of devices may include anchor user equipment (e.g., 412-418), and the apparatus is a target user equipment (e.g., 410).

In certain example embodiments, an apparatus 20 may include at least one processor 22, and at least one memory 24 including computer program code. The at least one memory 24 and the computer program code may be configured to, with storing instructions that, when executed by the at least one processor 22, cause the apparatus 20 to receive a request for synchronization information from a device (e.g., steps 2a-2e in FIGS. 4A-4C). According to other example embodiments, apparatus 20 may also be caused to perform a synchronization status evaluation as per the received request with one or more devices of a set of devices (e.g., step 3 in FIGS. 4A-4C). According to further example embodiments, apparatus 20 may be caused to transmit one or more messages to the device based on the synchronization status evaluation (e.g., steps 4a-4e in FIGS. 4A-4C). According to certain example embodiments, each of the one or more messages comprises the synchronization information. According to other example embodiments, apparatus 20 may be caused to receive a positioning session establishment request based on the synchronization information (e.g., step 6 in FIGS. 4A-4C). According to further example embodiments, apparatus 20 may be caused to perform positioning with the device in response to the positioning establishment request (e.g., steps 7 and 8 in FIGS. 4A-4C).

In certain example embodiments, performance of the synchronization status evaluation may include at least one of coordinating with one or more other devices of the set of devices on a positioning synchronization status (e.g., type 1 or type 2 information request), receiving positioning signals from the one or more other devices of the set of devices, calculating a signal transmission time based on location knowledge of the one or more devices of the set of devices, and estimating a synchronization accuracy by considering positioning reference signal transmission impairments (e.g., type 1 or type 2 information request), communicating with a positioning reference point, and requesting synchronization information of the one or more other devices of the set of devices (e.g., type 1 or type 2 information request). In some example embodiments, performance of the synchronization status evaluation may include estimating a synchronization positioning reference signal drift of the apparatus compared to a synchronization reference source or a positioning reference point of the apparatus (e.g., type 3 information request). In other example embodiments, the synchronization information comprises at least one of identifiers of the one or more other devices of the set of devices that are co-synchronized with the one or more devices of the set of devices (e.g., type 1 information), identifiers of one or more other devices of the set of devices, and a level of synchronization between the one or more devices of the set of devices and the one or more other devices of the set of devices (e.g., type 1 information), a level of synchronization between the one or more devices of the set of devices and the one or more other devices of the set of devices (e.g., type 2 information), an indication that the one or more devices of the set of devices uses a same synchronization reference source as the one or more other devices of the set of devices (e.g., type 3 information), or an indication of reliability of synchronization.

In certain example embodiments, the synchronization information may include synchronization status assistance information which indicates at least a synchronization level threshold (e.g., steps 2a-2e in FIGS. 4A-4C). In some example embodiments, the synchronization information may be transmitted from one of a network node, a peer anchor user equipment, or a global navigation satellite system (e.g., steps 4a-4e and 5 in FIGS. 4A-4C). In other example embodiments, the one or more other devices of the set of devices may include anchor user equipment (e.g., 412-418), and the device is a target user equipment (e.g., 410).

FIG. 7 illustrates a set of apparatuses 10 and 20 according to certain example embodiments. In certain example embodiments, the apparatus 10 may be an element in a communications network or associated with such a network, such as a target UE, anchor UE, mobile equipment (ME), mobile station, mobile device, stationary device, IoT device, or other device. It should be noted that one of ordinary skill in the art would understand that apparatus 10 may include components or features not shown in FIG. 7.

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IoT, Bluetooth, NFC, MultiFire, and/or any other radio access technologies. It should be noted that one of ordinary skill in the art would understand that apparatus 10 may include components or features not shown in FIG. 7.

As illustrated in the example of FIG. 7, apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 7, multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes and examples illustrated in FIGS. 1-6.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods and examples illustrated in FIGS. 1-6.

In some example embodiments, apparatus 10 may also include or be coupled to one or more antennas 15 for receiving a downlink signal and for transmitting via an UL from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an UL.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

For instance, in certain example embodiments, apparatus 10 may be controlled by memory 14 and processor 12 to receive one or more messages from one or more devices of a selected set of devices. According to certain example embodiments, each of the one or more messages may include synchronization information. Apparatus 10 may also be controlled by memory 14 and processor 12 to select, based on the synchronization information, at least one device of the selected set of devices for a positioning communication session. Apparatus 10 may further be controlled by memory 14 and processor 12 to perform a positioning estimate of the apparatus based on positioning signals received through the positioning communication session from the at least one device of the selected set of devices.

In other example embodiments, apparatus 10 may be controlled by memory 14 and processor 12 to receive a request for synchronization information from a device. Apparatus 10 may also be controlled by memory 14 and processor 12 to perform a synchronization status evaluation as per the received request with one or more devices of a set of devices. Apparatus 10 may further be controlled by memory 14 and processor 12 to transmit one or more messages to the device based on the synchronization status evaluation. According to certain example embodiments, each of the one or more messages may include the synchronization information. Further, apparatus 10 may be controlled by memory 14 and processor 12 to receive a positioning establishment request based on the synchronization information. In addition, apparatus 10 may be controlled by memory 14 and processor 12 to perform positioning with the device in response to the positioning establishment request.

As illustrated in the example of FIG. 7, apparatus 20 may be a network, core network element, or element in a communications network or associated with such a network, such as a gNB, cell, or NW. It should be noted that one of ordinary skill in the art would understand that apparatus 20 may include components or features not shown in FIG. 7.

As illustrated in the example of FIG. 7, apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 7, multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes and examples illustrated in FIGS. 1-4.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods and examples illustrated in FIGS. 1-4.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an UL).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for receiving one or more messages from one or more devices of a selected set of devices. According to certain example embodiments, each of the one or more messages may include synchronization information. The apparatus may also include means for selecting, based on the synchronization information, at least one device of the selected set of devices for a positioning communication session. The apparatus may further include means for performing a positioning estimate of the apparatus based on positioning signals received through the positioning communication session from the at least one device of the selected set of devices.

Other example embodiments may also be directed to an apparatus that includes means for receiving a request for synchronization information from a device. The apparatus may also include means for performing a synchronization status evaluation as per the received request with one or more devices of a set of devices. The apparatus may further include means for transmitting one or more messages to the device based on the synchronization status evaluation. According to certain example embodiments, each of the one or more messages may include the synchronization information. In addition, the apparatus may include means for receiving a positioning establishment request based on the synchronization information. Further, the apparatus may include means for performing positioning with the device in response to the positioning establishment request.

Certain example embodiments described herein provide several technical improvements, enhancements, and/or advantages. For instance, in some example embodiments, it may be possible to enhance positioning accuracy, in line with 3GPP requirements of accurate positioning as well as the customer requirements for industrial indoor positioning. In other example embodiments, it may be possible to provide faster positioning session establishment as the synchronization between anchor candidates may be provided to the server UE (or the target UE depending on the application) before the session starts, and thereby before the accuracy is evaluated. In other words, it may be possible to avoid (re)selection of anchor UEs due to anchor sync misalignment).

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### PARTIAL GLOSSARY

3GPP 3rd Generation Partnership Project
5G 5th Generation
5GCN 5G Core Network
5GS 5G System
BS Base Station
DL Downlink
eNB Enhanced Node B
gNB 5G or Next Generation NodeB
ID Identifier
IE Information Element
IIoT Industrial Internet of Things
IUC Inter-UE Coordination
LMF Location Management Function
LTE Long Term Evolution
NR New Radio
NW Network
PRS Positioning Reference Signal
RSRP Reference Signal Receive Power
RSS Reference Synchronization Source
RSTD Reference Signal Time Difference
RTOA Relative Time of Arrival
RTT Round Trip Time
SL Sidelink
TDOA Time Difference of Arrival
TRP Transmit Receive Point
UE User Equipment
UL Uplink
UWB Ultra-Wide Band
V2X Vehicle-to-Anything
WI Work Item

1. An apparatus, comprising:
at least one processor; and
at least one memory comprising computer program code,
the at least one memory and the computer program code are configured to, with storing instructions that, when executed by the at least one processor, cause the apparatus at least to:
receive one or more messages from one or more devices of a selected set of devices, wherein each of the one or more messages comprises synchronization information;
select, based on the synchronization information, at least one device of the selected set of devices for a positioning communication session;
select the selected set of devices from a plurality sets of devices;
transmit, to the one or more devices of the selected set of devices, a request for the synchronization information from the selected set of devices, wherein the selection of the set of devices is performed prior to the transmission of the request for the synchronization information; and
perform a positioning estimate of the apparatus based on positioning signals received through the positioning communication session from the at least one device of the selected set of devices.

2. The apparatus according to claim 1, wherein the synchronization information comprises at least one of the following:
identifiers of one or more other devices of the selected set of devices that are co-synchronized with the one or more devices of the selected set of devices and with one or more devices different from the selected set of devices,
identifiers of one or more other devices of the selected set of devices, and a level of synchronization between the one or more devices of the selected set of devices and the one or more other devices of the selected set of devices and with one or more devices different from the selected set of devices,
a level of synchronization between the one or more devices of the selected set of devices and one or more other devices of the selected set of devices and with one or more devices different from the selected set of devices,
an indication that the one or more devices of the selected set of devices uses a same synchronization reference source as the one or more other devices of the selected set of devices and with one or more devices different from the selected set of devices, or
an indication of reliability of synchronization.

3. (canceled)

4. The apparatus according to claim 1, wherein the positioning signals received from the at least one device of the selected set of devices comprises a positioning reference signal.

5. The apparatus according to claim 1, wherein the synchronization information comprises synchronization status assistance information indicating at least a synchronization level threshold.

6. The apparatus according to claim 1, wherein the positioning signals are received from the at least one device of the selected set of devices via one or both of a sidelink interface and an air interface.

7. The apparatus according to claim 1, wherein the synchronization information is received from one of:
a network node,
a peer anchor user equipment, or
a global navigation satellite system.

8. The apparatus according to claim 1, wherein the selected set of devices comprises anchor user equipment, and the apparatus is a target user equipment.

9. An apparatus, comprising:
at least one processor; and
at least one memory comprising computer program code,
the at least one memory and the computer program code are configured to, with storing instructions that, when executed by the at least one processor, cause the apparatus at least to:
receive a request for synchronization information from a device;
perform a synchronization status evaluation as per the received request with one or more devices of a set of devices;
transmit one or more messages to the device based on the synchronization status evaluation, wherein each of the one or more messages comprises the synchronization information;
receive a positioning session establishment request based on the synchronization information; and
perform positioning with the device in response to the positioning establishment request.

10. The apparatus according to claim 9, wherein performance of the synchronization status evaluation comprises at least one of the following:
coordinating with one or more other devices of the set of devices on a positioning synchronization status,
receiving positioning signals from the one or more other devices of the set of devices, calculating a signal transmission time based on location knowledge of the one or more devices of the set of devices, and estimating a synchronization accuracy by considering positioning reference signal transmission impairments, or
communicating with a positioning reference point, and requesting synchronization information of the one or more other devices of the set of devices.

11. The apparatus according to claim 9, wherein performance of the synchronization status evaluation comprises:
estimating a synchronization positioning reference signal drift of the apparatus compared to a synchronization reference source or a positioning reference point of the apparatus.

12. The apparatus according to claim 9, wherein the synchronization information comprises at least one of the following:
identifiers of the one or more other devices of the set of devices that are co-synchronized with the one or more devices of the set of devices,
identifiers of one or more other devices of the set of devices, and a level of synchronization between the one or more devices of the set of devices and the one or more other devices of the set of devices,
a level of synchronization between the one or more devices of the set of devices and the one or more other devices of the set of devices,
an indication that the one or more devices of the set of devices uses a same synchronization reference source as the one or more other devices of the set of devices, or
an indication of reliability of synchronization.

13. The apparatus according to claim 9, wherein the synchronization information comprises synchronization status assistance information which indicates at least a synchronization level threshold.

14. The apparatus according to claim 9, wherein the synchronization information is transmitted from one of:
a network node,
a peer anchor user equipment, or
a global navigation satellite system.

15. The apparatus according to claim 10, wherein the apparatus, the one or more other devices of the set of devices comprises anchor user equipment, and the device is a target user equipment.
